(19) United States
(12) Patent Application Publication
(10) Pub. No.: US 2005/0183909 A1
(43) Pub. Date: Aug. 25, 2005

(54) Disc brake rotor assembly and method for producing same

(76) Inventors: Charles Benjamin Rau III, Gig Harbor, WA (US); Dallas W. Jolley JR., University Place, WA (US)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 11/041,398

(22) Filed: Jan. 21, 2005

Related U.S. Application Data
(60) Provisional application No. 60/558,761, filed on Apr. 1, 2004.
(60) Provisional application No. 60/538,274, filed on Jan. 21, 2004.

(51) Int. Cl. F16D 65/78

(52) U.S. Cl. 188/218 XL; 188/18 A

(57) ABSTRACT

Novel composite disc brake rotor assemblies are provided, along with novel and efficient methods for manufacturing them. Preferably, the rotor assemblies comprise annular wear plates formed of particle reinforced aluminum-based metal matrix composite (MMC), ceramic matrix composite (CMC), or of ‘carbon graphite foam.’ The wear plates, made of a first material, are attached to annular surfaces of a central rotor, made of a second material, by fusing bonding layers between the wear plates and the rotor surfaces. The bonding layers are comprised of at least one of a metal alloy having a melting temperature lower than that of either the first or second materials, and a high-temperature adhesive. Preferably, the wear plates comprise projections that are positioned within adjacent receiving recesses in the center rotor. The bonding layers and projections enhance thermal and acoustical transference between the wear plates and the center rotor section. Carbon graphite foam provides for substantially enhanced heat transference. Use of the fusable binding layer, or adhesive provides for an efficient, low cost method of manufacturing for composite disc brake rotor assemblies.

### CROSS-REFERENCE TO RELATED APPLICATIONS

This application claims the benefit of priority to U.S. Provisional Patent Application Ser. Nos. 60/558,761, filed 1 Apr. 2004, and 60/538,274, filed 21 Jan. 2004, both of which are incorporated by reference herein in their entirety.

### FIELD OF THE INVENTION

The invention generally relates to vehicle brakes, and more particularly to novel light-weight disc brake rotor assemblies.

### BACKGROUND

Conventional brake drums and brake disc rotors are manufactured from ductile iron, cast iron or steel. Such drums and rotors have mechanical and thermal properties sufficient to meet most practical requirements of drum and disc brake systems, but they are relatively heavy and adversely affect performance and fuel economy.

Attempts have been made to reduce the weight of brake drums and brake discs by manufacturing them from lighter materials such as aluminum and aluminum alloys. However, while aluminum and aluminum alloys, such as ‘319’ or ‘356,’ are relatively light, they do not possess adequate mechanical properties (e.g., high temperature strength, hardness and wear resistance) typically required for brake applications, including for disc brake applications.

Brake drums and brake discs have been homogeneously fabricated from aluminum-based metal matrix composite (MMC), comprising silicon carbide particulate reinforcement. Such aluminum MMC provides for reduced weight, improved mechanical and thermal properties relative to aluminum and aluminum alloys, and is commercially available, for example, under the name DURALCAN® (Alcan Aluminum Limited). However, there are significant disadvantages with such homogeneous MMC castings. MMC casting are expensive relative to iron and conventional aluminum alloys. Additionally, compared to iron and conventional aluminum castings, aluminum MMC castings are relatively difficult to machine because of the silicon particulate reinforcement.

Disc brake rotors comprising ‘friction plates’ have been described, in which only the friction plate portions of the rotor assembly are formed of a reinforced aluminum alloy, while the remainder of the brake disc rotor is a conventional aluminum alloy (e.g., ‘319’ or ‘356’). Such prior art friction plate-bearing brake disc rotors are constructed by securing a reinforced aluminum alloy preform mixture into a conforming annular recessed portion of the disc brake rotor body (U.S. Pat. No. 5,183,632). Additionally, generally hat-shaped rotor bodies comprised of a conventional alloy have been cast in situ with a precast MMC rotor inserts (i.e., spaced friction plates) (U.S. Pat. No. 5,620,042); that is, using an insert-type secondary casting procedure. However, such hybrid disc rotor assemblies have substantial shortcomings relating to poor acoustical behavior (i.e., brake noise), and, importantly, poor thermal conductivity from the friction plate to the conventional alloy of the center rotor section.

There is, therefore a pronounced need in the art for fundamentally improved composite vehicular disc brake assemblies and rotors that are not only light weight and possess adequate mechanical properties, but that have improved thermal and acoustical behavior. There is also a need in the art to incorporate sensor devices, sensor materials or heat transfer-enhancing materials into brake disc rotors. There is a further need in the art to provide an efficient, low-cost manufacturing process for composite disc rotor assemblies that departs from conventional insert-type second casting procedures.

### SUMMARY OF THE INVENTION

Particular embodiments of the present invention provide novel and fundamentally improved composite disc brake rotors. The inventive rotors comprise an annular center rotor section formed of a first material, and a pair of annular or generally annular wear plates formed of a second material and attached to outer surfaces of the rotor by means of a bonding layer. In the context of an operative disc brake assembly, the external surfaces of such bonded wear plates would be generally disposed to be engaged by a pair of brake pads of the assembly.

Preferably the first material (e.g., rotor) is conventional aluminum or aluminum alloy, and the second material (e.g., wear plates) consists of, or comprises at least one material selected from the group consisting of: aluminum-based metal matrix composite (MMC), comprising a particulate reinforcement (e.g., DURALCAN®, containing silicon carbide, and manufactured by Alcan Aluminum Limited); ceramic matrix composite (CMC); ‘carbon graphite foam; or manganese-bronze having a particulate reinforcement such as, but not limited to silicon carbide (e.g., from about 10% to about 35%).

In particular embodiments, the bonding layer comprises a metal alloy (e.g., 1100 aluminum) having a melting temperature lower than that of either the first or the second materials, and is fused between the internal surfaces of the wear plates and the outer surfaces of the center rotor section. Preferably, for bonding layers comprising 1100 aluminum and the like, the bonding layer also comprises an amount of zinc or tin suitable to confer enhanced bonding (most likely by lowering the melting temperature of the bonding layer). According to the present invention, such zinc and tin additives can thus be use to ‘fine-tune’ bonding layers to particular wear plate and rotor compositions, and also to ‘fine-tune’ the manufacturing process. Preferably, the bonding layers, whether fused aluminum based or high-temperature adhesive comprise one or more additional materials to enhance thermal conduction. Preferably, the material comprises ‘carbon graphite foam.’

In alternative embodiments, the boding layer is an adhesive (e.g., high-temperature adhesive). Preferably, such adhesives are used in combination with either ceramic matrix composite (CMC) wear plates.

Additional embodiments provide novel methods for manufacturing of the inventive composite disc brake rotors, comprising obtaining a pair of cast, annular or generally annular wear plates formed of a first material and attaching them to a center rotor section formed of a second material by means of fused bonding layers, or adhesives (e.g., high-temperature adhesives). Each wear plate has an internal and an external surface. The internal surface of each of the wear plates is attached to a different outer surface of the rotor by means of fusing of bonding layers or adhesive between the internal surfaces of the wear plates and the corresponding outer surfaces of the rotor. Preferably, the bonding layer comprises a metal alloy (e.g., 1100 aluminum) having a melting temperature lower than that of either the first or the second materials, each bonding layer being fused between the internal surfaces of the wear plates and the corresponding outer surfaces of the center rotor section. Preferably, for bonding layers comprising 1100 aluminum and the like, the bonding layer also comprises an amount of zinc or tin suitable to confer enhanced bonding (most likely by lowering the melting temperature of the bonding layer). In alternative embodiments, the boding layer is an adhesive (e.g., high-temperature adhesive). Preferably, such adhesives are used in combination with, for example, ceramic matrix composite (CMC) wear plates. Preferably, the bonding layers, whether fused aluminum based or high-temperature adhesive comprise one or more additional materials to enhance thermal conduction. Preferably, the material comprises ‘carbon graphite foam.’

Preferably, the first material (e.g., wear plates) consists of, or comprises at least one material selected from the group consisting of: aluminum-based metal matrix composite (MMC), comprising a particulate reinforcement (e.g., DURALCAN®, containing silicon carbide, and manufactured by Alcan Aluminum Limited); ceramic matrix composite (CMC); ‘carbon graphite foam’; or manganese-bronze having a particulate reinforcement such as, but not limited to silicon carbide (e.g., from about 10% to about 35%). Preferably, the second material (rotor) is conventional aluminum or aluminum alloy (e.g., 356 or 359 aluminum). In particular embodiments, fusing is achieved by casting the rotor in situ in a mold already containing the precast wear plates with the bonding layers applied to, or positioned adjacent to the interior surfaces thereof. In alternate preferred embodiments, the metal alloy (e.g. 1100) bonding layer is suitably aligned between the outer surfaces of a cast center rotor section and corresponding interior surfaces of the cast wear plates prior to, and during fusing of the bonding layers by, for example, inductive welding during manufacturing of the inventive composite disc rotors (e.g., using a hydraulic press and induction welding of components aligned under pressure). In particular embodiments, alignment of wear plates onto center section before applying pressure or fusing can be enhanced with alignment pins embedded and protruding from center section face, to corresponding alignment holes on wear plate face with bonding layer. Alternatively, such pins can protrude from the inner face of the wear plate to alignment holes of the center section face. Preferably, for high-temperature adhesive applications, adhesive is suitably aligned between the outer surfaces of a cast center rotor section and corresponding interior surfaces of the cast wear plates prior to, and during manufacturing of composite disc rotors using, for example, a hydraulic press.

In preferred embodiments, each wear plate further comprises at least one integral projection (e.g., raised surfaces or pillars) projecting from the internal surface thereof, and each outer surface of the rotor comprises at least one corresponding receiver recess sized to receive the projection of the internal surface of the wear plate positioned adjacent thereto. Preferably, each bonding layer comprises or forms an aperture, with the projection of the adjacent wear plate extending therethrough. Alternatively such projections arise from the center rotor section and are received into the wear plate.

Alternate embodiments have a center rotor section further comprising at least one recessed cavity for holding a sensor device, sensor material or a heat transfer-enhancing material (e.g., sodium metal or carbon fiber foam). The cavity is sized to hold the sensor device, sensor material or heat transfer-enhancing material in a position adjacent to, or substantially adjacent to one of the bonding layers.

According to the present invention, the bonding layers enhance thermal conductivity between the wear plates and the center rotor section, and additionally and surprisingly optimize acoustic frequency transfer to the center rotor section, particularly in the context of the above-described integral projections’ communicating between the wear plate and the rotor. According to the present invention, at least one of the size, shape, composition and disposition of the integral projections (e.g., raised surfaces or pillars) serves to ‘tune’ or optimize the thermal and acoustic behavior of the disc brake rotor within an operative disc brake assembly, and to resist slippage of the wear plate on the rotor surface.

### BRIEF DESCRIPTION OF THE DRAWINGS

FIG. 1 is an exploded perspective view of one embodiment of the inventive disc brake rotor.

FIG. 2 is an enlarged perspective cross-sectional view of a finished inventive disc brake rotor assembly of FIG. 1, and showing the bonded composite wear plates.

FIG. 3 is a perspective view of a fully assembled disc brake rotor assembly of FIG. 1.

FIG. 4 is an exploded perspective view of another embodiment of the inventive disc brake rotor assembly having one or more recessed pockets or cavities in the rotor for incorporation of a sensor device, sensor material, heat transfer-enhancing material, or combinations thereof.

FIG. 5 is an enlarged perspective cross-sectional view of a finished inventive disc brake rotor assembly of FIG. 4, and showing the bonded composite wear plates and pocket with incorporated heat transfer-enhancing material (e.g., metallic sodium).

### DETAILED DESCRIPTION OF THE INVENTION

Particular embodiments of the present invention provide novel composite disc brake rotors comprising flat annular wear plates consisting of or comprising at least one material selected from the group consisting of: aluminum-based metal matrix composite (MMC), comprising a particulate reinforcement; ceramic matrix composite (CMC); ‘carbon graphite foam’; or manganese-bronze having a particulate reinforcement such as, but not limited to silicon carbide (e.g., from about 10% to about 35%). The wear plates are attached to the outer annual surfaces of a rotor made of a second material (e.g., 356 or 359 aluminum) by fusing of bonding layers having a melting temperature lower than that of either the first or the second materials (e.g., 1100 aluminum), or by use of high-temperature adhesives (e.g., particularly in the case of CMC wear plates).

Additional embodiments provide for novel methods of manufacturing of composite disc brake rotors.

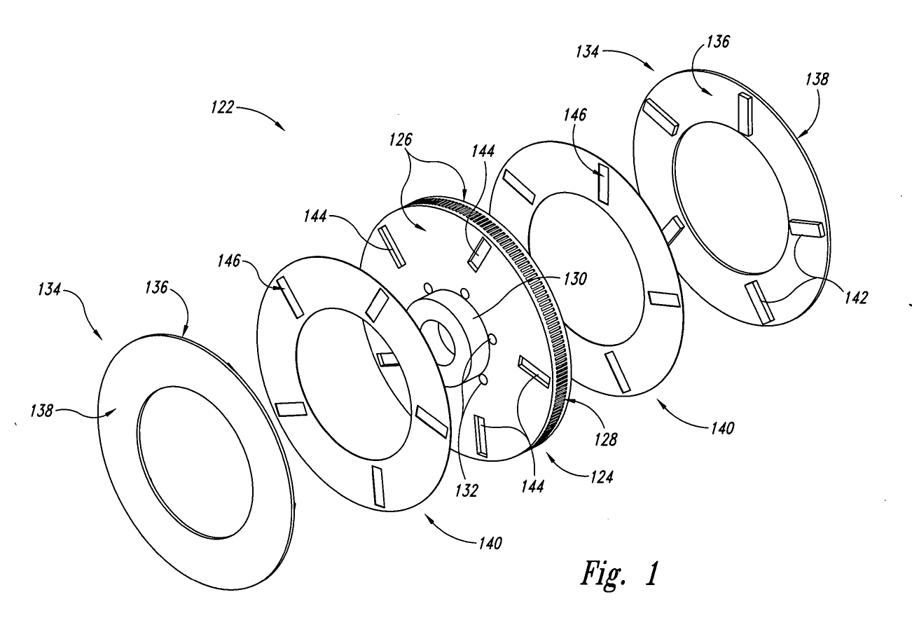

FIG. 1 shows an exploded perspective view of a composite disc brake rotor assembly 122 according to one embodiment of the present invention. The disc brake rotor assembly 122 comprises a center rotor section 124 formed of a first material, and having generally parallel flat annular outer surfaces 126. The center rotor 124 is optionally vented or cooled (e.g., by means of conventional air channels 128), and is optionally of a one-piece design with an integral inner hub (hat) section 130, or of a two-piece design comprising assembled rotor and a hub elements. Lug bolt channels 132 are typically present in the ‘bolt circle’ around the hat area. Preferably, the center rotor 122 is formed of, or is substantially comprised of a conventional aluminum or aluminum alloy, such as 356 (356A) or 359 aluminum, or art-recognized equivalents thereof.

The disc rotor assembly 122 additionally comprises a pair of generally flat annular wear plates 134 cast and formed of a second material, and each having internal 136 and external 138 surfaces. The wear plates 134 are formed of, or are substantially comprised of a second material, which is typically a aluminum-based metal matrix composite (MMC), comprising a particulate reinforcement, such as silicon carbide. Preferably, the wear plates 134 are formed of a particulate reinforced MMC having from about 10% to about 35% by volume inorganic materials of a thermal expansion factor less than the alloy. Preferably, the wear plate material is: DURALCAN® (manufactured by Alcan Aluminum Limited), having silicon carbide particles; or is a ceramic matrix composite (CMC). Preferably, the wear plates consisting of or comprising at least one material selected from the group consisting of: aluminum-based metal matrix composite (MMC), comprising a particulate reinforcement; ceramic matrix composite (CMC); ‘carbon graphite foam’; or manganese-bronze having a particulate reinforcement such as, but not limited to silicon carbide (e.g., from about 10% to about 35%). Preferably, the wear plates comprise carbon graphite foam.

The center rotor section 124, as well as the annular wear plates 134 are cast in a mold.

The casting process is performed by any suitable casting process, including but not limited to die casting, sand casting, permanent mold casting, squeeze casting, or lost foam casting. Preferably, casting is by die-casting. Alternatively, casting of the center rotor section 124, as well as the annular wear plates 134 is by spin-casting, such as that generally described in U.S. Pat. No. 5,980,792 to Chamlee (incorporated herein by reference in its entirety). For example, aluminum-based metal matrix composite (MMC) comprising a particulate reinforcement (e.g., Duralcan®) containing silicon carbide) is centrifugally spin-casted to cause and create functionally beneficial particulate (sic) distributions (gradients). In the present instance such casting methods increase particle density at friction surfaces.

Alternatively, aluminum-based alloys, including eutectic and hypereutectic alloys such as 380, 388, 398, 413, or others such as 359-356-6061, optionally containing particulate reinforcement such as silicon carbide, or aluma oxides, ceramic powders or blends, can be cast into (e.g., by infiltration casting) a ceramic fiber-based porous ‘preform’ of desired specification using discontinuous alumina-silicate (e.g., Kaowool Saffil Fibers), silicon carbide, ceramic powders, or blends of the preceding. Reinforced or non-reinforced aluminum-based alloys infiltrate the ‘preform’ during the casting procedure, making a MMC with selective reinforcement. Preferably, casting process is performed by a suitable method, including, but not limited to die casting. Alternatively, permanent mold high-vacuum, squeeze casting, lost foam, or centrifugal casting (e.g., U.S. Pat. No. 5,980,792) can be employed.

In a particularly embodiments, the aluminum-based alloys (e.g., eutecic, hypereutectic, or otherwise), with or without particulate reinforcement are cast into (e.g., infiltration casting) a ‘preform’ of porous ‘carbon graphite foam’ (with or without particulate reinforcement, such as silicon carbide). Carbon graphite foam (developed at Oak Ridge National Laboratory, USA) has high thermal conductivity and also acts as super-conductor (see, e.g., U.S. Pat. Nos. 6,673,328, 6,663,842, 6,656,443, 6,398,994, 6,387,343 and 6,261,485, all of which are incorporated by reference herein in their entirety). Preferably the silicon carbide volume should be from about 10% to 35% to provide desired friction at wear plate rubbing surface. Infiltration of un-reinforced or reinforced alloy into carbon graphite foam ‘preform’ is during a suitable casting procedure including, but not limited to die casting, high-vacuum permanent mold casting, squeeze casting, or centrifugal casting. According to the present invention, carbon graphite foam can be included in the compositions of at least one of the central rotor, the wear plates, and the bonding layer (further described below). Preferably, carbon graphite foam can is included at least in the composition of the wear plates.

The disc rotor assembly 122 further comprises bonding layers 140, comprising a metal alloy having a melting temperature lower than that of either the first or the second materials (or alternatively comprising a high-temperature adhesive). During assembly of the disc brake rotor assembly 122, the metal alloy bonding layers 140 are fused (melted), between the internal surfaces 136 of the friction plates and the outer surfaces 126 of the center rotor 124. Preferably, the bonding layer is formed of, or is substantially comprised of 1100 aluminum, or art-recognized equivalents thereof. The bonding layer can be a layer generated by spraying methods. For example, flame-spraying can be used to generate a bonding layer material of 1100 aluminum. Alternatively the bonding layer can be a layer cut (e.g., die-cut) from a flat sheet. For example, die-cutting of 1100 aluminum sheet can be used to generate bonding layer material. Preferably, the thickness of the bonding layer is from about 0.005 to about 0.020 inches, or from about 0.001 to about 0.20 inches, or from about 0.01 to about 0.10 inches. More preferably, the thickness of the bonding layer is from about 0.005 to about 0.020 inches. Preferably, the bonding layer comprises a metal alloy (e.g., 100 aluminum) having a melting temperature lower than that of either the first or the second materials, each bonding layer being fused between the internal surfaces of the wear plates and the corresponding outer surfaces of the center rotor section. Preferably, for bonding layers comprising 1100 aluminum and the like, the bonding layer also comprises an amount of zinc or tin suitable to confer enhanced bonding (most likely by lowering the melting temperature of the bonding layer). In alternative embodiments, the boding layer is an adhesive (e.g., high-temperature adhesive). Preferably, such adhesives are used in combination with, for example, ceramic matrix composite (CMC) wear plates. Preferably, the bonding layers, whether fused aluminum based or high-temperature adhesive comprise one or more additional materials to enhance thermal conduction. Preferably, the material comprises ‘carbon graphite foam.’

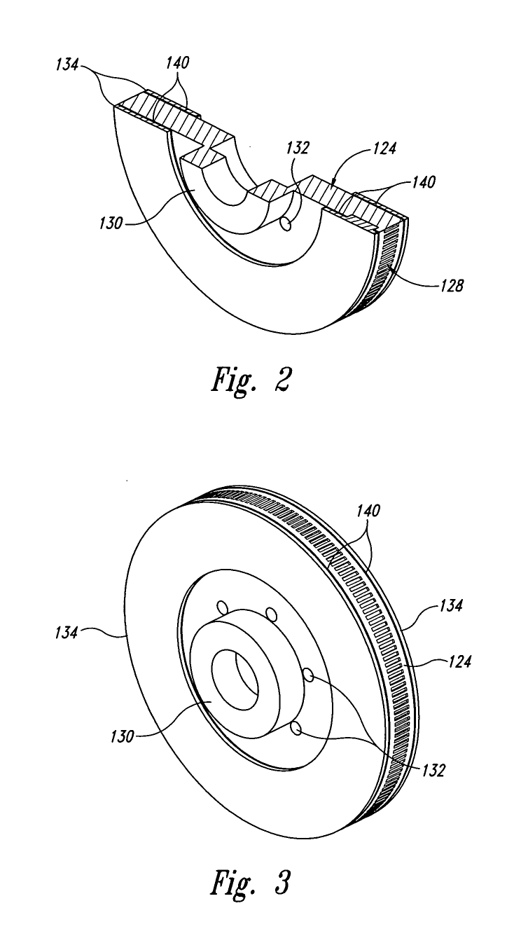

FIG. 2 shows an enlarged perspective cross-sectional view of a finished inventive disc brake rotor assembly embodiment 122 of FIG. 1, with the composite ware plates 134 attached to the center rotor section 124 via fused bonding layers 140. Lug bolt channels 132 are shown in the ‘bolt circle’ around the hub (hat) section 130 of the rotor. Venting or cooling air channels 128 are shown in the center rotor section 124.

FIG. 3 is a perspective view of a fully assembled disc brake rotor assembly embodiment 122 of FIG. 1, with the composite ware plates 134 attached to the center rotor section 124 via fused bonding layers 140. Lug bolt channels 132 are shown in the ‘bolt circle’ around the hub (hat) section 130 of the rotor.

In preferred embodiments (and with reference to FIG. 1) the wear plates 134 further comprises at least one integral projection 142 projecting from the internal surface 136 thereof, and the center rotor section 124 further comprises at least one receiver recess 144 in each of the outer surfaces 126 of the rotor, wherein the recesses are sized to receive the projections of the internal surface 136 of the wear plate 134 positioned adjacent thereto. Preferably, each bonding layer 140 further comprises or forms corresponding apertures 146, with the projections 142 of the adjacent wear plate extending therethrough. Preferably, each wear plate comprises from about 5 to about 10 integral projections 142, and the rotor comprises a corresponding number of respective receiver recesses 144. Alternatively, the projections extend from the outer surfaces of the center rotor section, through the bonding layer apertures, and into receiving recesses in the inner surfaces of the wear plates. Preferably, the projections extend from the wear plates, and into receiving recesses on the rotor.

According to particular embodiments of the present invention (and referring to FIG. 1), the fused bonding layers 140 adhere to, and enhance bonding of the first and second materials, thus providing for enhanced acoustical and thermal transference between the wear plates 134 and the center rotor 124. According to the present invention, the disc brake rotor assembly 122 thus has surprisingly improved thermal and acoustic behavior, as well as improved structural properties, particularly in the context of the above-described integral projections. Heat is more efficiently transferred from the wear plates to the center rotor (preferably vented rotor center), and squeals and creep groan are reduced, relative to prior art disc assemblies lacking the instant inventive bonding layers. Preferably, carbon graphite foam is included in at least one of the wear plates (including the integral projections), and the bonding layers to further enhance thermal conductivity, providing substantially more efficient transfer of heat from the friction surface, through the wear plate and boding layer to the center rotor, and providing a fundamentally improved disc brake system.

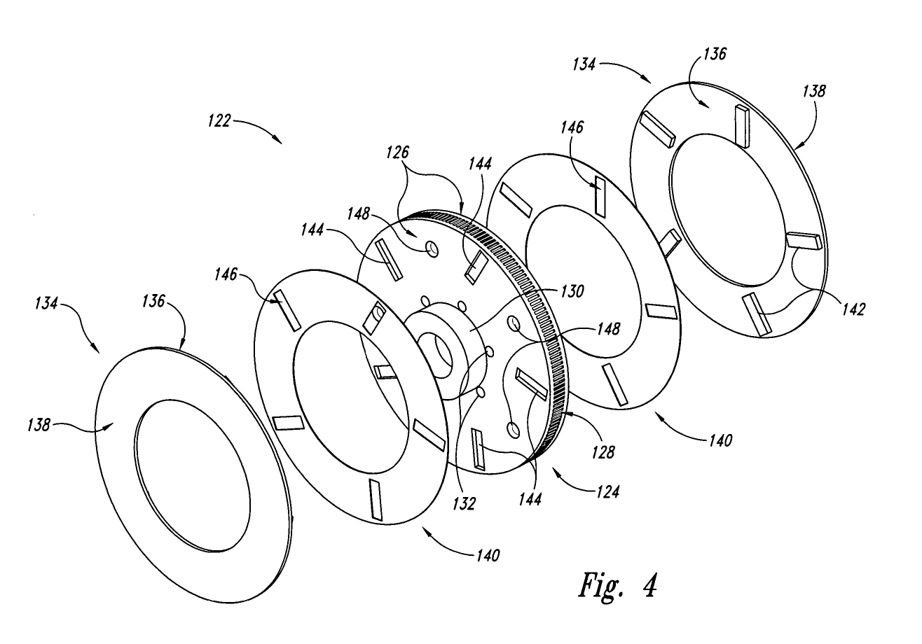

According to particular embodiments of the present invention (and referring to FIG. 1 and FIG. 4), the integral projections 142 are positioned within the receiver recesses 144 of the assembled composite disc rotor 122 (or 222) and provide for enhanced acoustical transference (as well as thermal transference) between the wear plates 134 and the center rotor 124. According to the present invention, at least one of the size, shape, composition and disposition of the projections serves to ‘tune’ or optimize the acoustic behavior of the disc brake rotor within an operative disc brake assembly. The effect is to sequester both high and low noise frequencies to the center rotor. Furthermore, positioning of the integral projections 142 within the corresponding receiver recesses 144 serves to enhance mechanical attachment and resistance to operative slippage of the wear plates 134 with respect to the rotor surface 126.

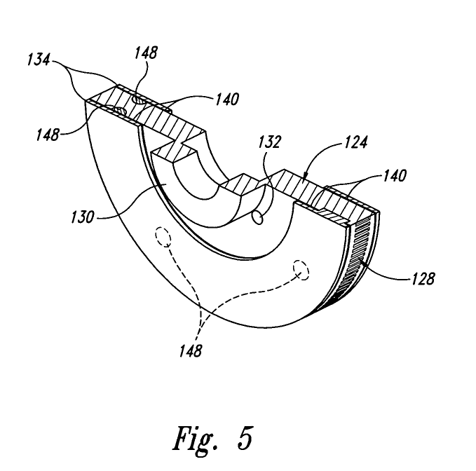

In alternate embodiments (and referring to FIG. 4 and FIG. 5), the present invention provides for composite rotors further comprising at least one recessed cavity in an outer surface thereof, wherein the cavity is sized to hold a sensor device or sensor material in a position adjacent, or substantially adjacent to one of the bonding layers. Preferably, the sensing device or sensing material is one of: a heat sensing device or material, respectively; a speed or motion sensing device or material, respectively; a vibration sensing device or material, respectively; a wear sensing device or material, respectively; a pressure sensing device or material, respectively; and a respective combination of two or more thereof. Preferably, the heat sensing device or material is a thermal voltaic cell, or a thermal voltaic material, respectively.

According to the present invention, such recessed cavities may also contain materials to enhance heat transfer (e.g., sodium metal or carbon graphite foam-based materials), galvanic materials (e.g., zinc), or other electromagnetically-related materials that may comprise an integral secondary ‘drag brake’ system (e.g., electromagnetically based). For example, such a drag brake system can be premised on use of graphite foam-based materials (or other suitable materials) in one or more of the above described elements of the inventive disc brake system.

The recessed cavities may be positioned in any suitable location within the surfaces of the center rotor section. Preferably, the recessed cavities are in a position of the rotor surface that is adjacent to a bonding layer. Preferably, for embodiments comprising integral wear plate projections 142 (e.g., see FIG. 1), the placement is between the receiver recesses 144 (see FIG. 1) in the outer surfaces 126 of the rotor, and in positions adjacent to the bonding layers.

In additional embodiments, the rotor further comprises at least one recessed cavity in an outer surface thereof, wherein the cavity is sized to hold a heat transfer-enhancing material in a position adjacent, or substantially adjacent to one of the bonding layers. Preferably, the heat transfer-enhancing material is metallic sodium, or carbon graphite foam. Preferably, the heat transfer-enhancing material is consists of, or comprises carbon graphite foam.

FIG. 4 is an exploded perspective view of one alternate embodiment 222 of the inventive disc brake rotor assembly having one or more recessed cavities 148 in the rotor 124 for incorporation of a sensor device, sensor material, heat transfer-enhancing material, or combinations thereof. The cavities 148 are sized to hold a sensor device or sensor material in a position just below the outer surface plane 126 of the rotor 124, but substantially adjacent to one of the bonding layers 140. The recessed cavities are in a position of the rotor surface 126 that is adjacent to a bonding layer 140. Preferably, for embodiments comprising integral wear plate projections 142 the placement is between the receiver recesses 144 in the outer surfaces 126 of the rotor, and in positions adjacent to the bonding layers 140.

FIG. 5 shows an enlarged perspective cross-sectional view of a finished inventive disc brake rotor assembly embodiment 222 of FIG. 4, with the bonded composite wear plates 134 and recessed cavities 148 filled, or substantially filled with a heat transfer-enhancing material (e.g., metallic sodium, or a material consisting of or comprising carbon graphite foam). Preferably, the recessed cavities are filled a material consisting of or comprising carbon graphite foam, and the material is adjacent to the fused bonding layers 140 in the finished disc rotor assembly 222.

Particular embodiments of the present invention thus provide for a composite disc brake rotor assembly 122, comprising: a rotor 124 formed of a first material and having a pair of annular outer surfaces 126; a pair of annular wear plates 134 formed of a second material, and each having internal 136 and external 138 surfaces, the internal surface 138 of each wear plate being positioned adjacent to a different one of the outer surfaces 126 of the rotor 124; and bonding layers 140, comprising a metal alloy having a melting temperature lower than that of either the first or the second materials, each bonding layer 140 being fused between the internal surface 136 of one of the wear plates and the corresponding outer surface 126 of the rotor. Alternatively, the bonding layer is a high-temperature adhesive.

In preferred embodiments, the wear plates 134 consist of, comprise, or substantially comprise a friction material selected from the group consisting of carbon graphite foam, ceramic matrix composite (“CMC”) having a two- or three-dimensionally interconnected crystalline ceramic phase and a non-contiguous metal phase dispersed within the interconnected ceramic phase (see, e.g., U.S. Pat. Nos. 5,620,791, 5,878,849 and 6,458,466, all of which incorporated herein by reference in their entirety), and combinations thereof.

The ceramic phase of the CMC may be a boride, oxide, carbide, nitride, silicide or combination thereof. Combinations include, for example, borocarbides, oxynitrides, oxycarbides and carbonitrides. The ceramic may include various dopant elements to provide a specifically desired microstructure, or specifically desired mechanical, physical, or chemical properties in the resulting composite. The metal phase of the CMC may be a metal selected from the Periodic Table Groups 2, 4-11, 13 and 14 and alloys thereof.

In particular embodiments, the CMC is produced by infiltrating a porous ceramic body with a metal, thus forming a composite. Such infiltration involves, for example, forming a porous ceramic preform prepared from ceramic powder, such as in slip casting (e.g., a dispersion of the ceramic powder in a liquid, or as in pressing (e.g., applying pressure to powder in the absence of heat), and then infiltrating a liquid metal into the pores of said preform.

In particular embodiments, the friction material comprises a ceramic-metal composite comprised of a metal phase and a ceramic phase dispersed within each other, wherein the ceramic phase is present in an amount of at least 20 percent by volume of the ceramic-metal composite. In particular embodiments, the braking component is a metal substrate, such as aluminum, having laminated thereto a ceramic metal composite of a dense boron carbide-aluminum composite having high specific heat and low density.

It will be appreciated that the disc brake rotor 122 may be used in conjunction with a variety of art-recognized brake assembly structures.

Methods of Manufacture

A novel and substantially less expensive disc brake manufacturing process is achieved by employing a fusable bonding layer (or in some instances adhesive boding layers) to avoid insert-type second casting procedures of the prior art that involve e.g., placement of wear plates into a rotor mold, followed by traditional casting, in situ, of the center rotor section.

With reference to FIG. 1, particular embodiments of the present invention provide novel methods for manufacturing of composite disc brake rotors, comprising obtaining a pair of cast generally annular wear plates 134 formed of a first material and attaching them to a center rotor section 124 formed of a second material by means of fused bonding layers 140, or alternatively adhesive bonding layers Each cast wear plate has an internal 136 and an external 138 surface. The internal surface 136 of each of the wear plates is attached to a different outer surface 126 of the center rotor section 124 by fusing of bonding layers 140 between the internal surfaces 136 of the wear plates and the corresponding outer surfaces 126 of the rotor.

In preferred embodiments, the bonding layers 140 comprise a metal alloy (e.g., 1100 aluminum) having a melting temperature lower than that of either the first or the second materials, each bonding layer 140 being fused between the internal surface 136 of one of the wear plates and the corresponding outer surface 126 of the rotor.

Preferably the first material (wear plates) comprises at least one material selected from the group consisting of: aluminum-based metal matrix composite (MMC), comprising a particulate reinforcement (e.g., DURALCAN®, containing silicon carbide; manufactured by Alcan Aluminum Limited); ceramic matrix composite (CMC); and ‘carbon graphite foam,’ and the second material (rotor) is conventional aluminum or aluminum alloy (e.g., 356 or 359 aluminum).

In particular embodiments, fusing is achieved by casting the rotor in situ in a mold already containing the cast wear plates 134 with the bonding layers 140 applied to, or positioned adjacent to the interior surfaces 136 thereof.

In alternate, preferred embodiments, the bonding layers 140 (e.g. 1100) are suitably aligned under pressure between the outer surfaces 126 of a cast center rotor section and the corresponding interior surfaces 136 of the cast wear plates prior to, and during fusing (melting) of the bonding layers. Preferably, fusing is by induction welding (e.g., involving attachment of suitably placed positive and negative electrodes) during manufacturing of the inventive composite disc rotors (e.g., using a hydraulic press and induction welding of components aligned under pressure). In particular embodiments, alignment of wear plates onto the center rotor section (before applying pressure or fusing) is enhanced by means of alignment pins embedded and protruding from center section face, which communicate with alignment holes on wear plate face. Alternatively, such pins can protrude from the inner face of the wear plate to alignment holes of the center section face. Preferably, for high-temperature adhesive applications, adhesive is suitably aligned between the outer surfaces of a cast center rotor section and corresponding interior surfaces of the cast wear plates prior to, and during manufacturing of composite disc rotors using, for example, a hydraulic press.

According to particular aspects of the present invention (and with reference to FIG. 1), disc brake rotor problems arising from poor acoustic behavior and poor thermal conductivity can be addressed by incorporation of tuning fork-like fingers or projections 142 from the interior surfaces 136 of the wear plates 134 (or, alternatively, projections from the center rotor faces to the receiving recesses in the wear plate inner surfaces). For example, during assembly of the finished disc rotor, positioning of the projections 142 within corresponding receiving recesses 144 of the outer surfaces 126 of the center rotor section 124 provides for alignment, and increased thermal and acoustic transference to the center section.

Additionally, the use of fused bonding layers 140 enhances bonding between the wear plates 134 and the center rotor section 124, and provides for increased thermal and acoustic transference to the center section. Preferably, the bonding layers 140 are formed of a relatively low melting temperature alloy such as 1100 aluminum, or an equivalent alloy having a melting temperature lower than the material of the center rotor 124 or the material of the wear plates 134. The bonding layers 140 are fused during the manufacturing process, and act as an adhesive that improves bonding between the surfaces of the wear plates 134 and center rotor section 124. The 1100 aluminum or other low temp alloys can be optionally sprayed on (flame spray), or die-cut from 0.005 to 0.020 flat sheet. For example, die-cutting of 1100 aluminum sheet can be used to generate bonding layer material. Preferably, the thickness of the bonding layer is from about 0.005 to about 0.020 inches, or from about 0.001 to about 0.20 inches, or from about 0.01 to about 0.10 inches. More preferably, the thickness of the bonding layer is from about 0.005 to about 0.020 inches. Preferably, for bonding layers comprising 1100 aluminum and the like, the bonding layer also comprises an amount of zinc or tin suitable to confer enhanced bonding (most likely by lowering the melting temperature of the bonding layer). In alternative embodiments, the boding layer is an adhesive (e.g., high-temperature adhesive). Preferably, such adhesives are used in combination with, for example, ceramic matrix composite (CMC) wear plates. Preferably, the bonding layers, whether fused aluminum based or high-temperature adhesive comprise one or more additional materials to enhance thermal conduction. Preferably, the material comprises ‘carbon graphite foam.’

In a alternate preferred embodiment (with reference to FIG. 1), a novel method for manufacturing a composite disc brake rotors comprises: obtaining a pair of cast annular wear plates 134 formed of a first material, and each having internal 136 and external 138 surfaces; and attaching the internal surface 136 of each wear plate to a different outer surface 126 of a rotor 124 formed of a second material, the attaching involving, at least in part, fusing of bonding layers 140 comprising a metal alloy having a melting temperature lower than that of either the first or the second materials, each bonding layer 140 being fused between the internal surface 136 of one of the wear plates and the corresponding outer surface 126 of the rotor.

In some alternate embodiments, fusing is achieved by casting the rotor 124 in situ in a mold already containing the cast wear plates 134 with the bonding layers 140 applied to, or positioned adjacent to the interior surfaces 136 thereof.

Preferably, the bonding layers 140 are suitably aligned between the outer surfaces 126 of a cast center rotor section and the corresponding interior surfaces 136 of the cast wear plates prior to, and during fusing of the bonding layers by inductive welding. Preferably, the rotor, bonding layers 140 and wear plates 134 are suitably aligned under pressure prior to and during fusing of the bonding layers. Preferably, the pressure is from about 0.5 to about 15 tons. Preferably, the pressure is exerted by means of a hydraulic press driving at least one of two opposed members, each member having a surface conforming to the shape of a wear plate 134.

In preferred embodiments, the bonding layer 140 is provided in the form of at least one of flame-sprayed 1100 aluminum, or die-cut 1100 aluminum sheeting. Preferably, provision of the bonding layer is by flame-sprayed 1100 aluminum.

In particular embodiments, the thickness of the bonding layer 140 is from about 0.005 to about 0.020 inches, from about 0.001 to about 0.20 inches, or from about 0.01 to about 0.10 inches. Preferably, the thickness of the bonding layer 140 is from about 0.005 to about 0.020 inches.

Bonding layers of high-temperature adhesives are alternately used in place of fused aluminum-based layers. Preferably, such adhesive layers are used in the context of CMC wear plate attachment.

Preferably, the second material (for center rotor 124) is at least one of aluminum and an aluminum alloy, and the first material (for wear plates 134) consists of, or comprises a material selected from the group consisting of: a aluminum-based metal matrix composite (MMC) with a particulate reinforcement (e.g., DURALCAN®, containing silicon carbide; manufactured by Alcan Aluminum Limited); ceramic matrix composite (CMC); and ‘carbon graphite foam.’ Preferably, the aluminum alloy comprises 356 or 359 aluminum, and the particulate reinforcement is silicon carbide. Preferably the wear plates comprise ‘carbon graphite foam.’

According to aspects of the present invention, the fused bonding layer 140 enhances bonding of the first and second materials, and thus promotes thermal and acoustical conductivity between first and second materials. Preferably, the metal alloy of the bonding layer is one of 1100 aluminum and a variant thereof comprised substantially of 1100 aluminum. In particular embodiments, the bonding layer comprises ‘carbon graphite foam.’

In preferred embodiments, each wear plate 134 further comprises at least one integral projection 142 projecting from the internal surface 136 thereof, and the rotor 124 further comprises at least one receiver recess 144 in each of the outer surfaces 126 of the rotor sized to receive the projection 142 of the internal surface 136 of the wear plate positioned adjacent thereto. Preferably, each bonding layer 140 further comprises at least one aperture 146, with the projection 142 of the adjacent wear plate extending therethrough. According to aspects of the present invention, at least one of the size, shape and disposition of the projection is selected to optimize or tune the acoustic behavior of the rotor within an operative disc brake assembly. Alternatively, the projections can be from the center rotor, being received in the inner surface of the wear plate.

In alternate preferred embodiments (and with reference to FIG. 4 and FIG. 5), the rotor 124 further comprises at least one recessed cavity 148 in an outer surface 126 thereof, the cavity sized to hold a sensor device or sensor material in a position adjacent to one of the bonding layers 140. Preferably, the sensing device or sensing material is one of a heat sensing device or material, respectively, a speed or motion sensing device or material, respectively, a vibration sensing device or material, respectively, a wear sensing device or material, respectively, a pressure sensing device or material, respectively, and a respective combination of two or more thereof. Preferably, the heat sensing device or material is a thermal voltaic cell, or a thermal voltaic material, respectively.

In alternate embodiments, the rotor 124 further comprises a recessed cavity 148 in an outer surface 126 thereof, wherein the cavity is sized to hold a heat transfer-enhancing material in a position adjacent to one of the bonding layers 140. Preferably, the heat transfer-enhancing material consists of, or comprises metallic sodium, or a material consisting of or comprising carbon graphite foam). Preferably, the recessed cavities are filled a material consisting of or comprising carbon graphite foam, and the material is adjacent to the fused bonding layers 140 in the finished disc rotor assembly 222.

### EXAMPLE 1

### Manufacturing of Composite Disc Rotors Using a Hydraulic Press and Induction Welding of Components Aligned Under Pressure

With reference to FIG. 1 and FIG. 4, a hydraulic press (pressure clamp) with a minimum of 15-ton capacity is used in the final assembly of components aligned or stacked in the following order: wear plate 134 (with interior surface 136 and projections 142 facing the bonding layer), bonding layer 140, outside surfaces of center rotor section 126, bonding layer 140, and wear plate 134 (with interior surface 136 and projections 142 facing bonding layer).

Alternatively the bonding layer 140 is flame-sprayed onto the interior surface 136 of the wear plates prior to alignment of the sprayed wear plates and the center rotor section.

Optional elements such as sensor devices, sensor materials or heat transfer-enhancing materials (e.g., sodium metal or carbon graphite foam) are placed into conforming recessed cavities 144 of the center rotor section as the components are aligned and juxtaposed. The aligned assembly is then placed onto the lower mandrel of a hydraulic press having top and bottom mandrels with surfaces conforming to the shape of wear plates 134.

Alternatively, alignment of the components is achieved by sequential stacking of the components, in the above-described order, onto the lower conforming mandrel surface, and then securing the aligned, stacked assembly between the lower and upper conforming mandrel surfaces. Additionally, as described herein above, alignment pins can be used.

Hydraulic pressure is applied to the pressure clamp, whereby the pressurized conforming mandrel surfaces further serve to accurately align the upper and lower wear plates 134. Positive-and-negative electrodes are attached to the assembly by the use of induction, and electrical current flow through the assembly causes the bonding layers 140 (e.g., 1100 aluminum) to fuse (soften and melt), bonding the aligned components together. Once melting of the bonding layers is complete, the electrical current is stopped, and the hydraulic pressure is subsequently released.

The fused disc rotor assembly is subjected to heat treatment, and finished by final machining if required.

While various embodiments and preferred embodiments of the present invention have been illustrated and described herein, it will be appreciated that various changes can be made therein without departing from the spirit and scope of the invention.

1. A composite disc brake rotor, comprising:
a rotor formed of a first material and having a pair of annular outer surfaces;
a pair of annular wear plates formed of a second material, and each having an internal and an external surface, the internal surface of each wear plate being positioned adjacent to a different one of the outer surfaces of the rotor; and
bonding layers, comprising a metal alloy having a melting temperature lower than that of either the first or the second materials, each bonding layer being fused between the internal surface of one of the wear plates and the corresponding outer surface of the rotor.

2. The composite rotor of claim 1, wherein the first material comprises at least one of aluminum and an aluminum alloy, and the second material comprises at least one material selected from the group consisting of a aluminum-based metal matrix composite (MMC) with a particulate reinforcement, ceramic matrix composite (CMC), and carbon graphite foam.

3. The composite rotor of claim 2, wherein the aluminum alloy comprises 356 or 359 aluminum, and the particulate reinforcement is silicon carbide.

4. The composite rotor of claim 1, wherein the fused bonding layer permeates, at least to some extent into each of the first and second materials, thereby enhancing thermal conductivity between first and second materials.

5. The composite rotor of claim 1, wherein the metal alloy of the bonding layer is one of 1100 aluminum and a variant thereof comprised substantially of 1100 aluminum.

6. The composite rotor of claim 1, wherein the bonding layer comprises carbon graphite foam.

7. The composite rotor of claim 1, wherein each wear plate further comprises at least one integral projection projecting from the internal surface thereof, and the rotor further comprises at least one receiver recess in each of the outer surfaces of the rotor sized to receive the projection of the internal surface of the wear plate positioned adjacent thereto.

8. The composite rotor of claim 1, wherein each wear plate further comprises carbon graphite foam.

9. The composite rotor of claim 7, wherein each bonding layer further comprises an aperture, with the projection of the adjacent wear plate extending therethrough.

10. The composite rotor of claim 7, wherein each wear plate comprises from about 5 to about 10 integral projections, and the rotor comprises corresponding receiver recesses.

11. The composite rotor of claim 1, wherein the rotor further comprises at least one recessed cavity in an outer surface thereof, the cavity sized to hold a sensor device or sensor material in a position adjacent, or substantially adjacent to one of the bonding layers.

12. The composite rotor of claim 11, wherein the sensing device or sensing material is one of a heat sensing device or material, respectively, a speed or motion sensing device or material, respectively, a vibration sensing device or material, respectively, a wear sensing device or material, respectively, a pressure sensing device or material, respectively, and a respective combination of two or more thereof.

13. The composite rotor of claim 12, wherein the heat sensing device or material is a thermal voltaic cell, or a thermal voltaic material, respectively.

14. The composite rotor of claim 1, wherein the rotor further comprises a recessed cavity in an outer surface thereof, the cavity sized to hold a heat transfer-enhancing material in a position adjacent to one of the bonding layers.

15. The composite rotor of claim 14, wherein the heat transfer-enhancing material is at least one of metallic sodium, and carbon graphite foam.

16. A method for manufacturing a composite disc brake rotor comprising:
obtaining a pair of cast, annular wear plates formed of a first material, and each having an internal and an external surfaces; and
attaching the internal surface of each wear plate to a different outer surface of a rotor formed of a second material, the attaching involving, at least in part, fusing of bonding layers comprising a metal alloy having a melting temperature lower than that of either the first or the second materials, each bonding layer being fused between the internal surface of one of the wear plates and the corresponding outer surface of the rotor.

17. The method for manufacturing of claim 16, wherein fusing is achieved by casting the rotor in situ in a mold already containing the cast wear plates with the bonding layers applied to, or positioned adjacent to the interior surfaces thereof.

18. The method for manufacturing of claim 16, wherein the bonding layers are suitably aligned between the outer surfaces of a cast rotor and the corresponding interior surfaces of the cast wear plates prior to, and during fusing of the bonding layers by inductive welding.

19. The method for manufacturing of claim 18, wherein the rotor, bonding layers and wear plates are suitably aligned under pressure prior to and during fusing of the bonding layers.

20. The method for manufacturing of claim 19, wherein the pressure is from about 0.5 to about 15 tons.

21. The method for manufacturing of claim 19, wherein the pressure is exerted by means of a hydraulic press driving at least one of two opposed members, each member having a surface conforming to the shape of a wear plate.

22. The method for manufacturing of claim 16, wherein the bonding layer is provided in the form of at least one of flame-sprayed 1100 aluminum, and die-cut 1100 aluminum sheeting.

23. The method for manufacturing of claim 16, wherein the thickness of the bonding layer is from about 0.005 to about 0.020 inches, from about 0.001 to about 0.20 inches, or from about 0.01 to about 0.10 inches.

24. The method for manufacturing of claim 16, wherein the second material is at least one of aluminum and an aluminum alloy, and the first material comprises at least one material selected from the group consisting of aluminum-based metal matrix composite (MMC) with a particulate reinforcement, ceramic matrix composite (CMC), and carbon graphite foam.

25. The method for manufacturing of claim 24, wherein the aluminum alloy comprises 356 or 359 aluminum, and the particulate reinforcement is silicon carbide.

26. The method for manufacturing of claim 16, wherein the fused bonding layer permeates, at least to some extent into each of the first and second materials, thereby enhancing thermal conductivity between first and second materials.

27. The method for manufacturing of claim 16, wherein the metal alloy of the bonding layer is one of 1100 aluminum and a variant thereof comprised substantially of 1100 aluminum.

28. The method for manufacturing of claim 16, wherein the bonding layer comprises carbon graphite foam.

29. The method for manufacturing of claim 16, wherein each wear plate further comprises at least one integral projection projecting from the internal surface thereof, and the rotor further comprises at least one receiver recess in each of the outer surfaces of the rotor sized to receive the projection of the internal surface of the wear plate positioned adjacent thereto.

30. The method for manufacturing of claim 16, wherein each wear plate further comprises carbon graphite foam.

31. The method for manufacturing of claim 29, wherein each bonding layer further comprises an aperture, with the projection of the adjacent wear plate extending therethrough.

32. The method for manufacturing of claim 29, wherein at least one of the size, shape, composition and disposition of the projection is selected to optimize or tune the acoustic behavior of the rotor within an operative disc brake assembly.

33. The method for manufacturing of claim 16, wherein the rotor further comprises a recessed cavity in an outer surface thereof, the cavity sized to hold a sensor device or sensor material in a position adjacent, or substantially adjacent to one of the bonding layers.

34. The method for manufacturing of claim 33, wherein the sensing device or sensing material is one of a heat sensing device or material, respectively, a speed or motion sensing device or material, respectively, a vibration sensing device or material, respectively, a wear sensing device or material, respectively, a pressure sensing device or material, respectively, and a respective combination of two or more thereof.

35. The method for manufacturing of claim 34, wherein the heat sensing device or material is a thermal voltaic cell, or a thermal voltaic material, respectively.

36. The method for manufacturing of claim 16, wherein the rotor further comprises a recessed cavity in an outer surface thereof, the cavity sized to hold a heat transfer-enhancing material in a position adjacent to one of the bonding layers.

37. The method for manufacturing of claim 36, wherein the heat transfer-enhancing material is at least one of metallic sodium, and carbon graphite foam.

38. A composite disc brake rotor, comprising carbon graphite foam.

39. A composite disc brake rotor, comprising a rotor and at least one wear plate, wherein at least one of the rotor, and the at least one wear plate comprises carbon graphite foam.

40. A composite disc brake rotor, comprising:
a rotor formed of a first material and having a pair of annular outer surfaces; and
a pair of annular wear plates formed of a second material, and each having an internal and an external surface, the internal surface of each wear plate being positioned adjacent to a different one of the outer surfaces of the rotor; wherein at least one of the wear plates comprises carbon graphite foam.

41. The composite disc brake rotor of claim 40, further comprising at least one bonding layer.

42. The composite disc brake rotor of claim 41 wherein the bonding layer comprises a metal alloy having a melting temperature lower than that of either the first or the second materials, and wherein the bonding layer is fused between the internal surface of the wear plates and the corresponding outer surface of the rotor.

43. A composite disc brake rotor, comprising:
a rotor formed of a first material and having a pair of annular outer surfaces;
a pair of annular wear plates formed of a second material, and each having an internal and an external surface, the internal surface of each wear plate being positioned adjacent to a different one of the outer surfaces of the rotor; and
bonding layers, comprising a high-temperature adhesive, each bonding layer being fused between the internal surface of one of the wear plates and the corresponding outer surface of the rotor, and wherein each wear plate further comprises at least one integral projection projecting from the internal surface thereof, and the rotor further comprises at least one receiver recess in each of the outer surfaces of the rotor sized to receive the projection of the internal surface of the wear plate positioned adjacent thereto.

44. The composite disc brake rotor of claim 43, wherein the wear plates comprise ceramic matrix composite (CMC).

45. The composite disc brake rotor of claim 43, wherein at least one of the rotor, wear plates, and the bonding layer comprises carbon graphite foam.
